(19) United States
(12) Patent Application Publication
(10) Pub. No.: US 2025/0360613 A1
(43) Pub. Date: Nov. 27, 2025

(54) MOTORIZED AMBULATORY ASSIST DEVICE

(71) Applicant: NIKE, Inc., Beaverton, OR (US)

(72) Inventors: Joseph B. Gault, West Linn, OR (US); Andrew C. Lau, Happy Valley, OR (US); Jazzmin P. Martinez, Beaverton, OR (US); Austin J. Orand, Portland, OR (US); Jan Raken, Seattle, WA (US); Richard K. Hansen, Vancouver, WA (US); Daniel Weeks, Portland, OR (US)

(73) Assignee: NIKE, Inc., Beaverton, OR (US)

(21) Appl. No.: 19/219,653

(22) Filed: May 27, 2025

Related U.S. Application Data
(60) Provisional application No. 63/651,435, filed on May 24, 2024.
(60) Provisional application No. 63/651,940, filed on May 24, 2024.

(51) Int. Cl. B25J 9/00; B25J 9/10; B25J 13/08

(52) U.S. Cl. CPC B25J 9/0006; B25J 9/104; B25J 13/088

(57) ABSTRACT

A motorized ambulatory assist device is configured to augment natural walking or running motion by applying torque to an article of footwear at specific points in a gait cycle. The device includes a shin-mounted control pack secured to a lower leg of a wearer, a drive unit rigidly coupled to the control pack, a lower control arm rotatably coupled to both the drive unit and the article of footwear, and a motor assembly that tensions a drive belt extending between the motor and the lower control arm. The device may include a quick disconnect coupling that enables selective attachment and detachment from the footwear, a fluid-filled bladder between the control board assembly and shin guard to dampen reactionary forces, and flexible battery packs integrated with elastic bands that secure the device to the wearer's leg.

### CROSS-REFERENCE TO RELATED APPLICATION

This application claims the benefit of priority to U.S. Provisional Application No. 63/651,435, filed May 24, 2024, and U.S. Provisional Application No. 63/651,940, filed May 24, 2024, both of which are incorporated by reference in their entirety.

### TECHNICAL FIELD

The present disclosure relates generally to ambulatory assist devices, and, in particular to lower-leg powered exoskeleton devices and hardware.

### BACKGROUND

Electronic assist devices have become increasingly popular in combination with traditionally manual forms of transportation. For example, bicycles have been augmented with pedal assist motors and electric scooters are now common in urban environments. However, similar electronic assist technologies have not been widely applied to the most basic form of human transportation: walking and running.

While powered exoskeleton designs exist for enhancing human strength and for clinical physical rehabilitation, these existing designs typically rely on bulky structure and equipment that is not suitable for general consumer use. Current exoskeletons are often cumbersome, heavy, and difficult to don and doff quickly, limiting their practicality for everyday activities or athletic training.

There exists a need for streamlined and minimized ambulatory assist devices that can achieve mass consumer adoption. Such devices should be lightweight, comfortable, easily attachable and detachable, and capable of effectively augmenting natural walking or running motions without the complexity and bulk of traditional exoskeletons. Additionally, these devices should be appropriate for non-clinical applications, such as athletic training or endurance enhancement during regular activities.

### SUMMARY

The present disclosure provides a motorized ambulatory assist device that is configured to augment the natural walking or running motion of a user. Unlike existing powered exoskeletons that are often bulky and intended primarily for clinical rehabilitation, the present design streamlines and minimizes the structure to achieve a device suitable for mass consumer adoption.

The ambulatory assist device generally includes a shin-mounted control pack secured to a lower leg of a wearer, a drive unit rigidly coupled to the control pack via an upper control arm, and a lower control arm rotatably coupled to both the drive unit and an article of footwear. The drive unit comprises a riser and a motor assembly attached to the riser. The motor assembly tensions a drive belt extending between the motor assembly and the lower control arm, applying force at specific points in the gait cycle to assist the user's natural motion.

The device is not intended as a full replacement for the user's natural ambulatory motion, but rather serves as an assist device to improve overall endurance or to supplement maximum effort during training. By encouraging plantar flexion during the push-off phase, the device helps reduce the effort required by the user's calf muscles, potentially increasing endurance or speed while reducing fatigue.

In some embodiments, the ambulatory assist device includes a quick disconnect coupling having a first portion provided on the lower control arm and a second portion configured to be provided on the article of footwear. The quick disconnect coupling allows for selective attachment and detachment of the ambulatory assist device from the article of footwear, enabling the user to quickly transition between assisted and unassisted motion.

In certain embodiments, the shin-mounted control pack includes a padded shin guard, a control board assembly, and a fluid-filled bladder provided between at least a portion of the control board assembly and the padded shin guard. The fluid-filled bladder comprises a first, upper fluid chamber in fluidic communication with a second, lower fluid chamber, with a necked transition zone limiting fluid movement between the chambers. This configuration helps dampen reactionary forces transmitted to the shin-mounted control pack during operation.

The ambulatory assist device may further include a closure for securing the shin-mounted control pack to the lower leg of the wearer. The closure may comprise one or more elastic bands configured to achieve a tension fit around a circumference of the lower leg. In some embodiments, one or more battery packs may be coupled to the elastic bands, wherein the battery packs are configured to at least partially conform to the curvature of the wearer's leg.

### BRIEF DESCRIPTION OF THE DRAWINGS

FIG. 1 is a perspective view of an individual wearing an ambulatory assist device on each leg.

FIG. 2A is a schematic lateral side view of a first embodiment of an ambulatory assist device.

FIG. 2B is a schematic medial side view of the ambulatory assist device of FIG. 2A.

FIG. 3 is a schematic exploded view of the ambulatory assist device of FIGS. 2A and 2B.

FIG. 4A is a schematic front-lateral side view of a second embodiment of an ambulatory assist device on a leg of a wearer.

FIG. 4B is a schematic rear-medial side view of the ambulatory assist device of FIG. 5A.

FIG. 5A is a schematic front-lateral side view of a shin-mounted control pack such as from the ambulatory assist device of FIGS. 4A and 4B.

FIG. 5B is a schematic front-medial side view of the shin-mounted control pack of FIG. 5A.

FIG. 6 is a rear-side view of an embodiment of a quick disconnect coupling in a disassembled state, illustrating a keyed post and a latching mechanism.

FIG. 7 is a rear-side view of the quick disconnect coupling of FIG. 6 in an assembled state.

FIG. 8 is a schematic rear-medial isometric view of the quick disconnect coupling of FIGS. 6-7.

FIG. 9 is a schematic exploded view of the quick disconnect coupling of FIG. 8, illustrating the keyed post, the mating quick disconnect receiver, and the latching mechanism components.

FIG. 10 is a schematic cross-sectional view of the quick disconnect coupling of FIG. 8 taken along line 10-10, showing the latching mechanism engaged with the mating quick disconnect receiver.

FIG. 11 is a schematic medial side view of a shin-mounted control pack with a fluid-filled bladder provided between a control board assembly and a padded shin guard.

FIG. 12 is a schematic exploded view of the shin-mounted control pack of FIG. 11, illustrating the first, upper fluid chamber, the second, lower fluid chamber, and the necked transition zone of the fluid-filled bladder.

FIG. 13 is a schematic exploded top-medial side view of a padded shin guard and magnetic quick release closure.

FIG. 14 is a schematic side view of the padded shin guard and magnetic quick release closure of FIG. 13 provided in a locked state.

FIG. 15 is a schematic side view of the padded shin guard and magnetic quick release closure of FIG. 13 provided in an unlocked state.

FIG. 16 is a schematic top-medial side view of the padded shin guard and magnetic quick release closure of FIG. 13 in a partially assembled state, showing the closure panel in the process of being secured to the padded shin guard.

FIG. 17 is a schematic bottom-medial isometric view of a flexible battery pack that may be used with an ambulatory assist device.

FIG. 18 is a schematic cross-sectional view of the flexible battery pack of FIG. 17, taken along line 18-18, showing the internal structure of the rigid cells and flexible sections.

### DETAILED DESCRIPTION

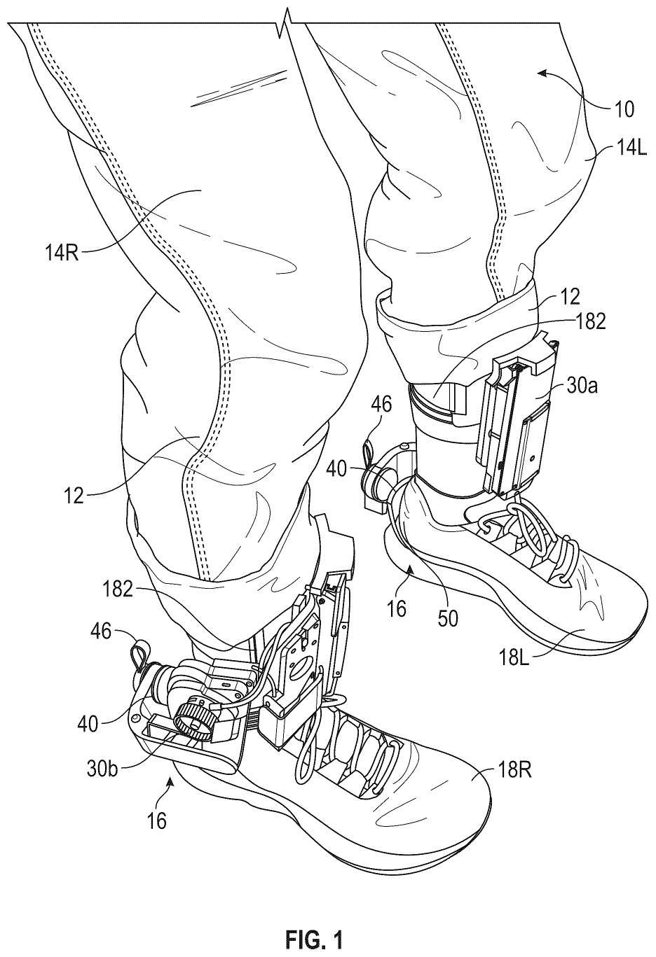

Referring to the figures, where like numerals refer to common elements across the various figures, FIG. 1 generally illustrates a user 10 having a first ambulatory assist device 30a secured to a lower leg 12 of a first, left leg 14L and additionally attached to a heel portion 16 of a left shoe 18L. Additionally, the user 10 has a second ambulatory assist device 30b secured to a lower leg 12 of a second, right leg 14R and additionally attached to a heel portion 16 of a right shoe 18R. In one configuration, the first ambulatory assist device 30a may be a mirror image of the second ambulatory assist device 30b (hereinafter referred to generically as the ambulatory assist device 30). As used herein, a “shoe” is an example of an article of footwear with which the present device 30 may be used. It should not be read as limiting, but rather as simply a generic example, and should be regarded as an interchangeable term meaning an article of footwear 18.

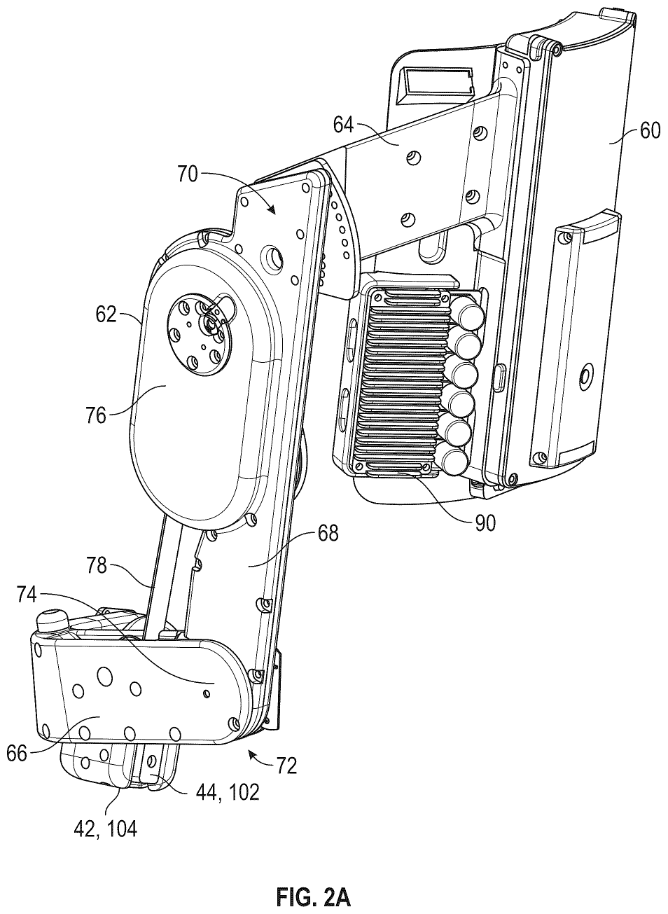

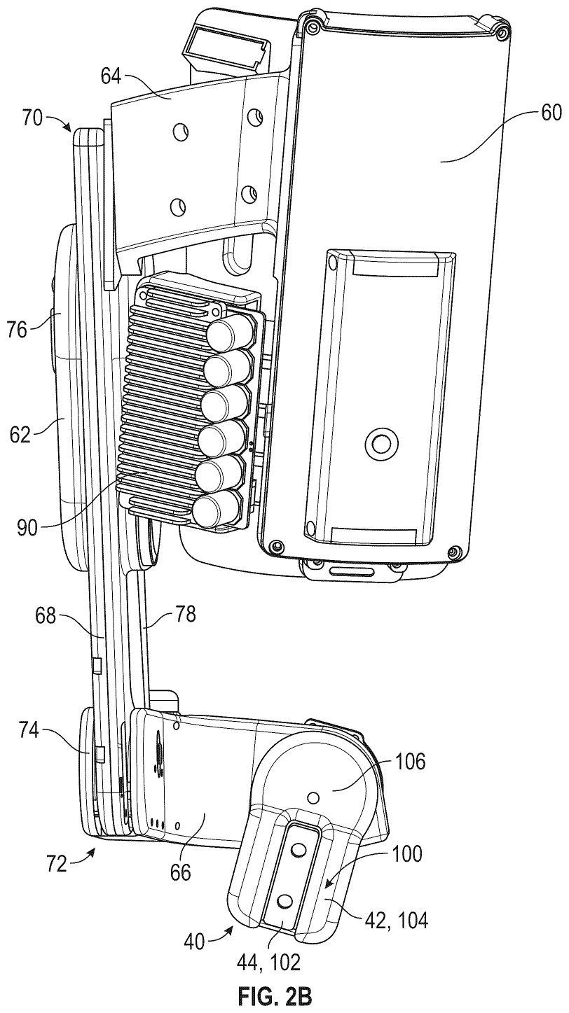

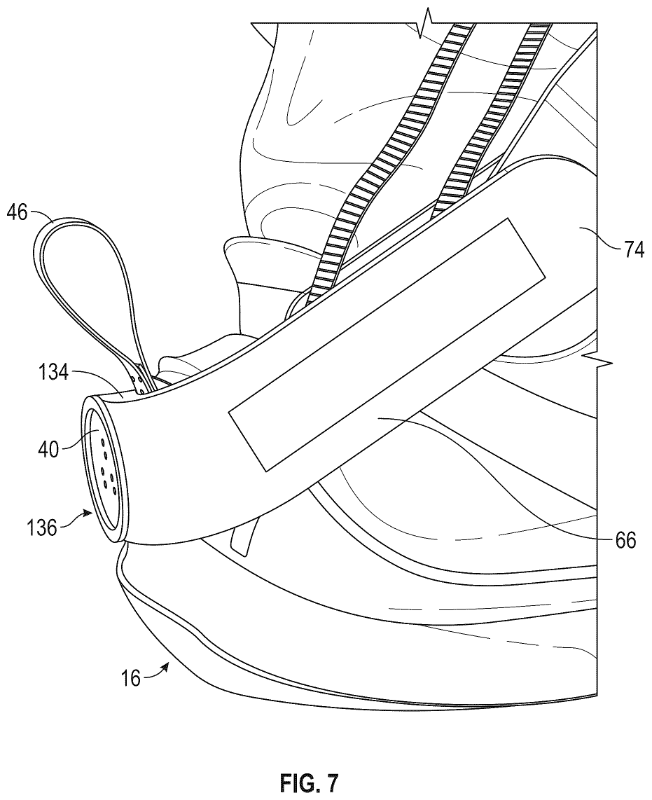

In some embodiments, the ambulatory assist device 30 may be rotatably coupled to the shoe 18, such as via a quick disconnect coupling 40. As will be discussed in greater detail below, and as shown in at least FIGS. 2A-2B, and FIG. 7 (among others) the quick disconnect coupling 40 may include a first portion 42 provided on the device side 30 that selectively interconnects with a second portion 44 provided on the article of footwear 18. Through the use of a user-activated release mechanism, the first portion 42 (on the device side) may selectively disengage with and be separated from the second portion 44 on the article of footwear. In one embodiment, the user-activated release mechanism may include and may be toggled by the user pulling on a release strap 46, thumb tab, lever, button, or other such spring-biased actuator.

In some configurations, the second portion 44 of the quick disconnect coupling 40 may be provided on or integrated into a posterior-most portion of the article of footwear 18. In some embodiments, this second portion 44 may be provided on or integrated into a heel counter 50 of the article of footwear 18. In other embodiments, the second portion 44 of the quick disconnect coupling 40 may be provided on or integrated into a bracket or other structure that wraps around the heel counter 50, or even that extends over the instep of the article of footwear 18.

The second portion 44 of the quick disconnect coupling 40 may further be attached to a plate (not shown) that extends forward across a portion of the article of footwear 18. When a force is applied to the article of footwear 18 by the ambulatory assist device 30 and through the posterior-located quick disconnect coupling 40, the stiffness of the plate may aid in transferring the applied load into a forefoot plantar flexion and effective toe-off while distributing the applied torques across the wearer's foot and minimizing stress concentrations. In some embodiments, the plate may be constructed from a lightweight, yet suitably stiff composite material such as a carbon fiber composite.

In some embodiments, the plate may be integrated into or may lie on top of the sole structure of the shoe 18. The plate may further extend across the entire length of the shoe (i.e., across the heel portion, the midfoot portion and the forefoot portion of the shoe). Further examples and explanation of the construction of the article of footwear 18, plate, and integration of the second portion 44 of the quick disconnect coupling 40 into the plate are provided in U.S. Provisional Patent No. 63/650,530, filed May 22, 2024, which is incorporated by reference in its entirety.

The ambulatory assist device 30 is designed to augment the user's natural gait by applying a torque to the shoe 18 at specific points in the gait cycle. By encouraging plantar flexion during the push-off phase, the device can help reduce the effort required by the user's calf muscles, potentially increasing endurance or speed while reducing fatigue. The timing and magnitude of the applied torque can be adjusted based on the user's needs and preferences, allowing for customization and adaptation to different walking or running styles.

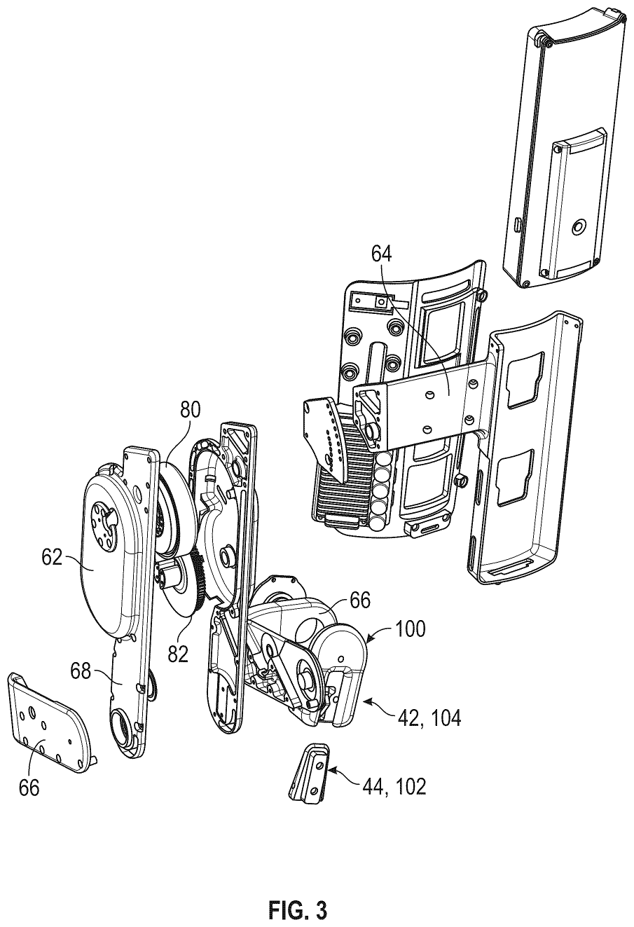

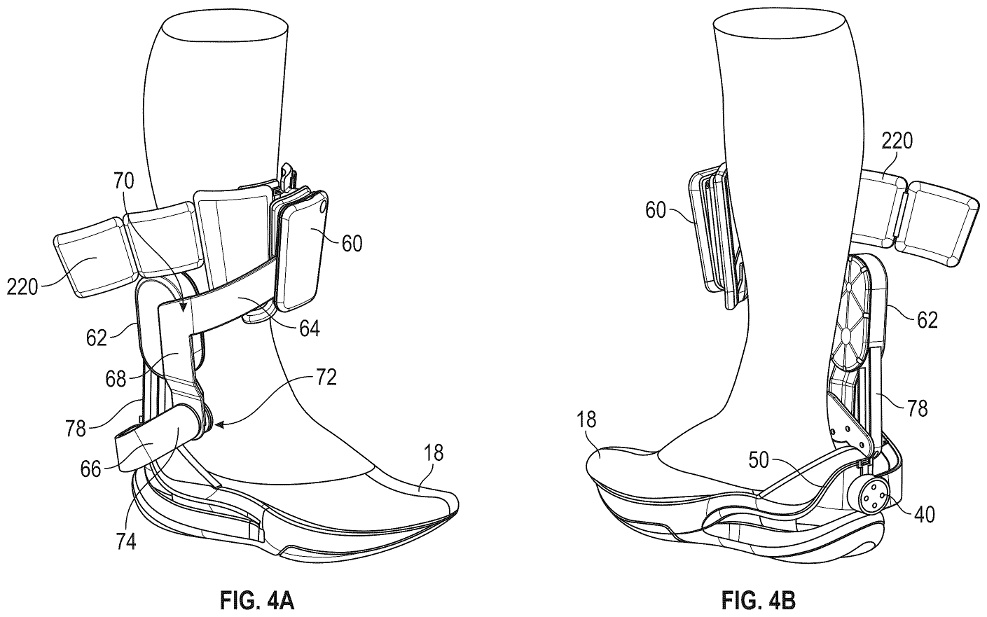

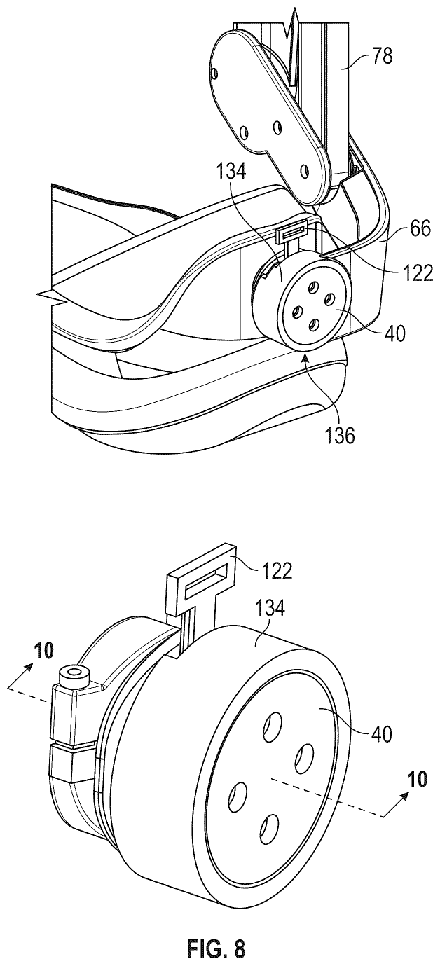

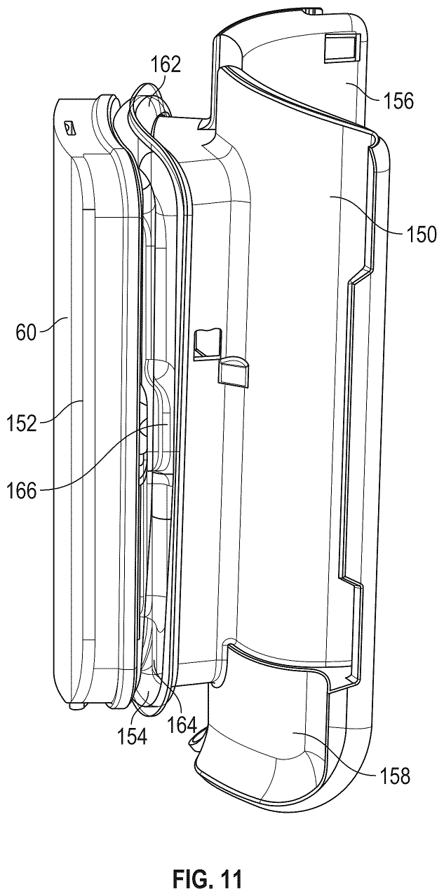

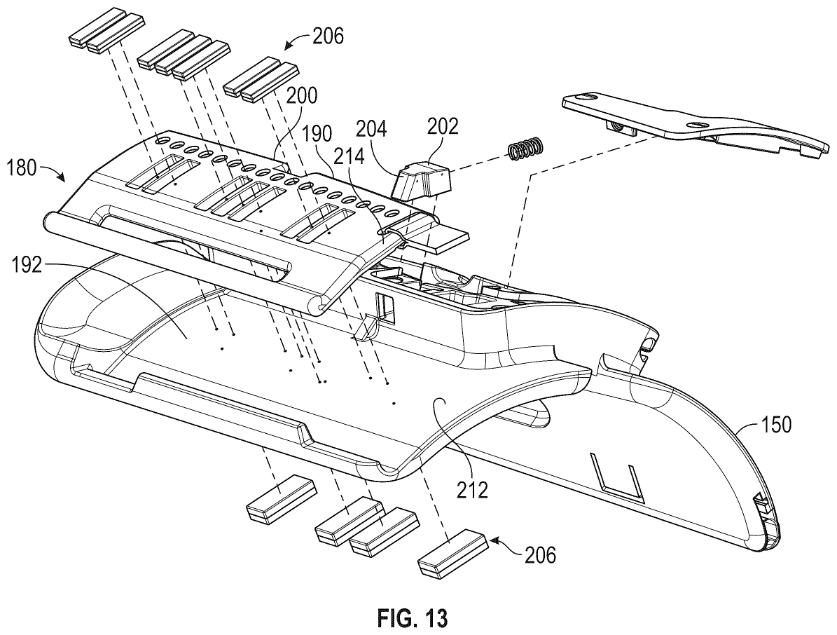

FIGS. 2A-3 schematically illustrate a first embodiment of the ambulatory assist device 30, while FIGS. 4A-10 schematically illustrate a second embodiment of the ambulatory assist device 30, and the design features shown in FIGS. 11-18 can optionally be used with either the first embodiment or the second embodiment of the ambulatory assist device 30. The two embodiments of the ambulatory assist mechanisms are similar in their operation, though have slight differences in construction that can be seen from the drawings.

### Basic Structure of the Ambulatory Assist Device

Referring generally to FIGS. 2A, 2B, 4A and 4B, each embodiment generally includes: a shin-mounted control pack 60; a drive unit 62; and a lower control arm 66. The drive unit 62 is rigidly coupled to the shin-mounted control pack 60 via an upper control arm 64, and the lower control arm 66 is rotatably coupled to both the drive unit 62 and the article of footwear 18. In the illustrated embodiments, the shin-mounted control pack 60 is intended to be worn on an anterior surface of the wearer's lower leg 12, the drive unit 62 is positioned on a lateral side portion of the wearer's lower leg 12, and the lower control arm 66 connects to a posterior portion of the article of footwear 18 via the quick disconnect coupling 40. In other embodiments, some or all of the control pack 60 may be integrated with the drive unit on the lateral side portion of the wearer's lower leg 12.

The drive unit 62 includes a riser 68 that is intended to extend approximately parallel to and along a length of the wearer's lower leg 12. As shown most clearly in FIGS. 2A, 2B, 4A, and 4B, the riser 68 includes a first end portion 70 that is coupled with the upper control arm 64, and a second end portion 72 that includes a first rotatable joint 74 to which the lower control arm 66 is coupled. When worn, the first end portion 70 is intended to be closer to the wearer's knee than the second end portion 72, which is intended to be closer to the wearer's foot.

The drive unit 62 further comprises a motor assembly 76 that is attached to or otherwise integrated with the riser 68. The motor assembly 76 is operatively configured to tension a drive belt 78 that extends between the motor assembly 76 and the lower control arm 66. As shown in FIGS. 3 and 6, the motor assembly 76 may include an AC or DC electric motor 80 and may further include a gearbox or transmission 82 in communication with the electric motor 80. In some embodiments, the electric motor 80 may be a high-torque, low-speed electric motor that is capable of generating sufficient force to assist the user's gait (i.e., via the intermediate gearbox or transmission 82).

The coupled gearbox or transmission 82 is operative to multiply the motor's torque output to further maximize the applied force. The drive belt 78 may be made from a durable, flexible material that can withstand the repeated stresses of the device's operation and, in some embodiments, may be a timing cable that has a toothed interior profile for added traction. In some embodiments, such as shown in FIGS. 2B and 4B, the drive belt 78 may extend around or may otherwise be attached to a pulley or other attachment point on the lower control arm 66. This pulley or attachment point may be offset from the first rotatable joint 74 to further increase the mechanical advantage of the motor 80. During actuation, the motor assembly 76 applies a force to the lower control arm 66 via the tensioned drive belt 78. This applied force causes the lower control arm 66 to pivot about the first rotatable joint 74 in a plane of motion that is approximately parallel to the anatomical sagittal plane of the wearer's body.

### Control Electronics

As generally illustrated in FIGS. 2A, 2B, 5, and 6, the shin-mounted control pack 60 may include control electronics 90 to both drive the electric motor 80 and to time the actuation of the electric motor 80 with the appropriate phase of the wearer's gait. The control electronics 90 may include one or more processors, controllers, memory devices, communication circuits, antenna, batteries, power electronics, accelerometers, inertial measurement units, gyrometers, or other such electronic components that may be required to drive the electric motor 80 or effectuate proper actuation timing.

In one embodiment, the control electronics 90 may be in communication with one or more sensors that are located apart from the shin-mounted control pack 60. For example, the control electronics 90 may receive an input from one or more pressure sensors provided within the article of footwear 18. In one configuration, such a pressure sensor may be integrated into the sole structure or the embedded plate within the article of footwear 18 and may be adapted to monitor pressure or foot-strike patterns to inform the control electronics 90 on the timing of the wearer's gait. Such a sensor may be in wireless communication with the shin-mounted control pack 60, for example, using an IEEE 802.11 or Bluetooth communications protocol. In other configurations, the generated sensory signals from the integrated pressure sensor may be communicated to the shin-mounted control pack 60 via direct wired communication (i.e., through the quick disconnect coupling 40).

In addition to pressure sensors in the article of footwear 18, the control electronics 90 may also receive input from other sensors, such as accelerometers, gyroscopes, or strain gauges, which can help to more accurately determine the user's gait phase and adjust the electric motor's actuation accordingly. These sensors may be located in the shin-mounted control pack 60, the drive unit 62, or even integrated into the lower control arm 66. By fusing data from multiple sensors, the control electronics 90 can create a more comprehensive picture of the user's movement and adapt the device's behavior in real-time to provide optimal assistance. Additional disclosure on control electronics, sensors, and system integration are provided in PCT Appl. No. PCT/US2023/031679, filed Aug. 31, 2023, which is incorporated by reference.

Additional manners of acquiring, managing, and analyzing sensed user motion, which may serve as the basis for dynamically adjusting the timing and intensity of the assistive ambulatory response can be found in US Patent Application Pub. No. 2021/0197021, which is incorporated by reference in its entirety and for all that it discloses. Further details of various embodiments of footwear sensors for sensing ground strikes and for adjusting timing are found in U.S. Patent Application Publications Nos. 2013/0213147 and US 2021/0197021, which are both incorporated by reference in their entirety. In addition to such embodiments, footwear sensors that may be used with the present ambulatory assist device may include one or more flexible sensors that are embedded into or otherwise affixed onto a fluid-filled cushioning device, such as an airbag that is integrated into the midsole. An embodiment of such a cushioning device is illustrated in and further described in U.S. Patent Application Pub. No. 2021/0368925, which is incorporated by reference in its entirety. Additional disclosure related to control electronics for ambulatory assist devices as well as related functionality, all of which may be used with the present system, are disclosed in U.S. patent application Ser. No. 18/444,340, filed 16 Feb. 2024, which is incorporated by reference in its entirety and for all that it discloses.

### Quick Disconnect Coupling

In the embodiment shown in FIGS. 2A-3, the quick disconnect coupling 40 relies on a slidable engagement between the first portion 42 and the second portion 44 of the quick disconnect coupling 40. In this first embodiment, the first portion 42 comprises a t-slot receiver 104, and the second portion 44 comprises a t-shaped feature 102. Such a slidable engagement utilizes a t-slot slide 100 to facilitate the interconnection. FIGS. 2A-3 illustrate this slidable engagement, where the t-shaped feature 102 would be fastened to the rear portion of the article of footwear 18, and the mating t-slot receiver 104 would extend over and around the t-shaped feature 102. A spring latch may then be used to selectively retain the t-shaped feature 102 within the t-slot receiver 104 to inhibit inadvertent removal during use.

As generally illustrated in FIGS. 2B and 3, the t-slot receiver 104 may be attached to the lower control arm 66 via a second rotatable joint 106. This second rotatable joint 106 may enable the article of footwear 18 to freely roll about an axis that is substantially parallel to a longitudinal axis of the article of footwear 18.

Referring to FIGS. 7-10, in a second configuration, the quick disconnect coupling 40 may comprise a first portion 42 that includes a keyed post 110, and a second portion 44 that includes a mating quick disconnect receiver 112. The keyed post 110 is configured to be inserted within the mating quick disconnect receiver 112. As shown in FIGS. 7-10, the mating quick disconnect receiver 112 may be integrated into the article of footwear 18; however, it is equally possible for the keyed post 110 to be integrated into the article of footwear 18 and the mating quick disconnect receiver 112 to be more proximate to the lower control arm 66.

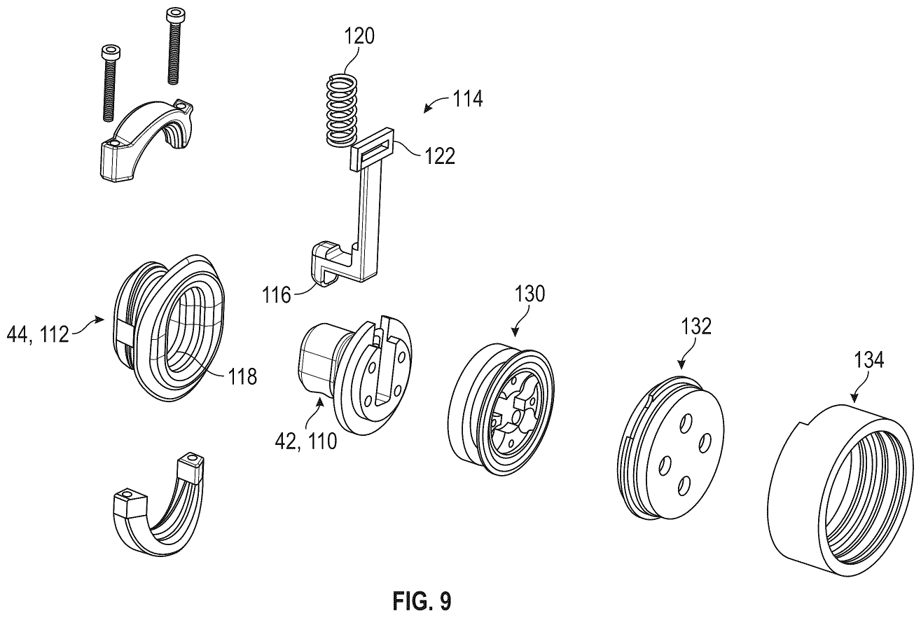

As generally illustrated in FIGS. 7 and 9, the keyed post 110 (and internal profile of the mating quick disconnect receiver 112) may have an oval, elliptical, or other non-radially symmetric cross-sectional profile that facilitates easy insertion while preventing unintended rotation of the keyed post 110 within the mating quick disconnect receiver 112. This quick disconnect coupling 40 allows for easy attachment and detachment of the ambulatory assist device 30 from the article of footwear 18. The keyed post 110 is designed to be inserted into and retained within the mating quick disconnect receiver 112 during use (i.e., where the mating quick disconnect receiver 112 is integrated into the carbon fiber plate in the midsole of the shoe 18). The keyed post 110 and mating quick disconnect receiver 112 may be made from durable materials such as aluminum, titanium, or high-strength plastic, and are precision-machined to ensure a secure and stable connection.

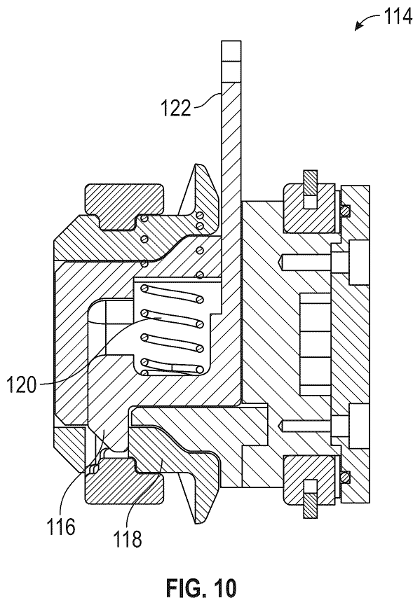

The quick disconnect coupling 40 in this second embodiment further includes a latching mechanism 114, which is activated by the user to release the keyed post 110 from the mating quick disconnect receiver 112. As illustrated in at least FIGS. 9 and 10, the latching mechanism 114 includes a latching protrusion 116 (referred to as the “latch 116”) that may selectively extend proud of the outer surface of the keyed post 110 and catch on a corresponding retention edge 118 of the mating quick disconnect receiver 112 when fully inserted. The latch 116 may be biased in this extended position via an interconnected spring 120. To remove the keyed post 110 from the mating quick disconnect receiver 112, a user may pull on an upstanding tab 122 (possibly via a pull tab or fabric loop 46) to reverse the bias/overcome the spring force and cause the latch 116 to retract within the keyed post 110. In doing so, the interference preventing free removal is eliminated, and the keyed post 110 may freely be withdrawn. In some embodiments, the receiver 112 may include a ramped portion that configured to selectively engage and retract the latch 116. More specifically, the ramped portion may be positioned such that if the post 110 is rotated relative to the receiver 112 by more than some absolute angle of rotation, the ramp causes the latch 116 to retract thus permitting the post 110 to be freely withdrawn from the receiver 112. This rotational disconnect may aid in preventing injury should an unexpected foot roll or torque occur.

With continued reference to FIGS. 9-10, extending outward from the keyed post 110 is a bearing shaft 130 and coupled cap 132. An annular portion 134 of the lower control arm 66 then encircles and is rotatably coupled to the bearing shaft 130 to form a third rotatable joint 136 (i.e., along with any required intermediate bearings that may be required to facilitate ease of rotation). This third rotatable joint 136 is configured to permit the article of footwear 18 to rotate relative to the lower control arm 66 about an axis that is substantially parallel to a longitudinal axis of the article of footwear 18.

During use, the lower control arm 66 transfers the force generated by the electric motor 80 to the article of footwear 18 via this third rotatable joint 136 and the quick disconnect coupling 40. Similar to the construction of the quick disconnect coupling 40, the lower control arm 66 and third rotatable joint 136 may be made from a lightweight, high-strength material such as aluminum, titanium, or carbon fiber, and is designed to withstand the repeated stresses experienced during use.

Further detail on the mating quick disconnect receiver 112 and interconnections between the mating quick disconnect receiver 112 and the article of footwear 18 are provided in U.S. Provisional Patent No. 63/650,530.

### Shin Guard and Fluid-Filled Damper

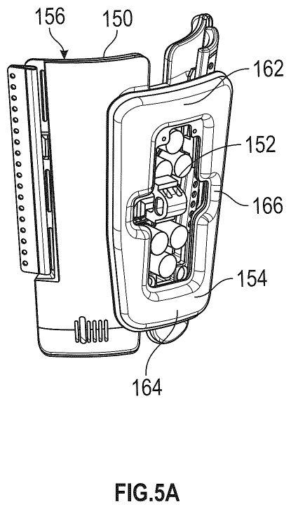

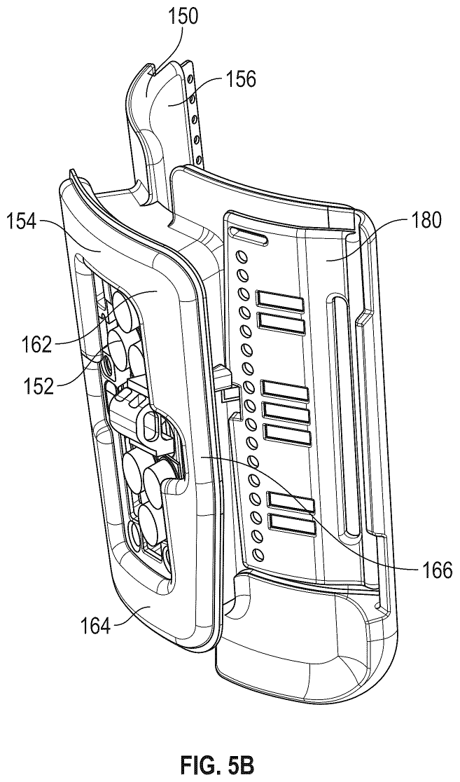

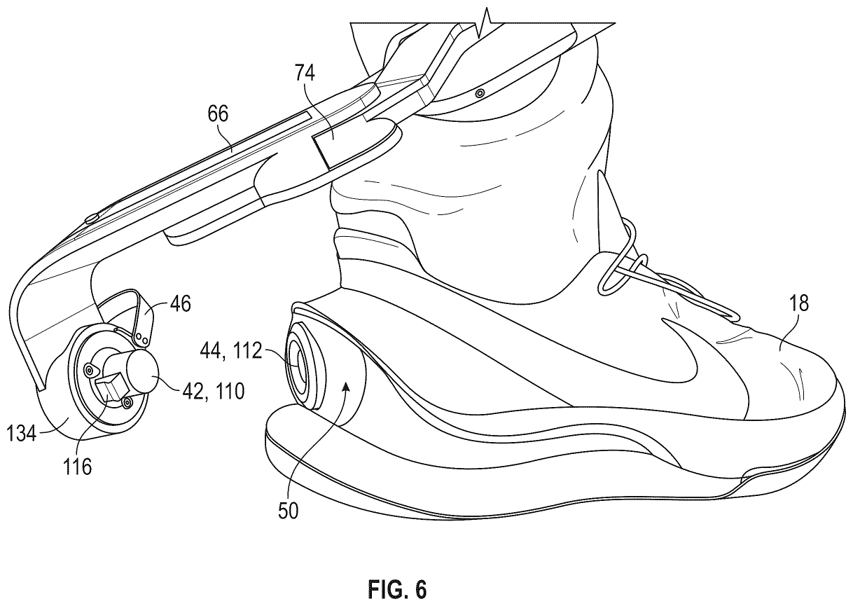

As generally shown in FIGS. 5A-5B and 11-12, the shin-mounted control pack 60 includes a padded shin guard 150, a control board assembly 152, and a fluid-filled bladder 154 provided between at least a portion of the control board assembly 152 and the padded shin guard 150. The padded shin guard 150 has a generally curved shape that includes a compliant padding on a concave side 156 that is intended to directly contact the wearer's lower leg 12. The control board assembly 152 is loosely mounted to the convex side 158 of the padded shin guard 150 and is also directly coupled to the upper control arm 64. In some configurations, the concept of “loose coupling” is meant to indicate that, though the components are permanently or semi-permanently attached to each other, the control board assembly 152 is capable of some limited motion relative to the padded shin guard 150.

During operation, when the motor assembly 76 tensions the drive belt 78 and ultimately draws the quick disconnect coupling 40 and heel upward, certain reactionary forces are transmitted to the shin-mounted control pack 60. Absent any accommodation, these repeated reaction forces may be irritating to the wearer and/or may cause the padded shin guard 150 to move relative to the wearer's shin. To account for this, the control board assembly 152 may be configured to rock/articulate across a limited angular range within the sagittal plane.

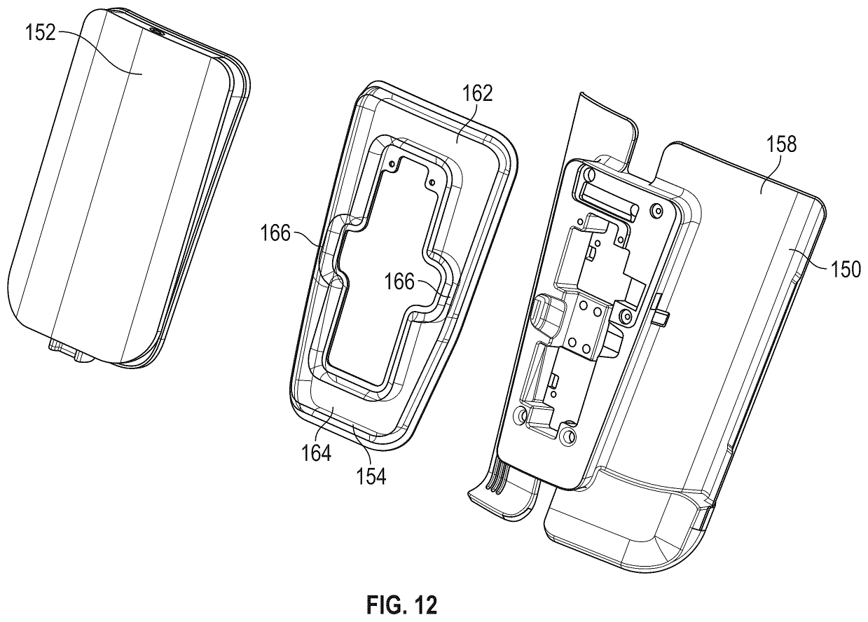

In an effort to dampen/dissipate these forces, the fluid-filled bladder 154 (e.g., an airbag) is provided between the control board assembly 152 and the padded shin guard 150. The fluid-filled bladder 154 is shown in greater detail in FIG. 12, where it is depicted having a first, upper fluid chamber 162 in fluidic communication with a second, lower fluid chamber 164. As the control board assembly 152 actuates the electric motor 80, the top/upper portion of the control board assembly 152 may be urged against the wearer's leg 12 (i.e., in a posterior direction). In doing so, the control board assembly 152 can apply a contact pressure against the first, upper fluid chamber 162 of the fluid-filled bladder 154. In doing so, the fluid (e.g., air) trapped inside the first, upper fluid chamber 162 may be forced into the second, lower fluid chamber 164. Such a fluid movement, however, may introduce a dampening effect as the fluid-filled bladder 154 may include a necked transition zone 166 that limits fluid movement between the first, upper fluid chamber 162 and the second, lower fluid chamber 164. As the tension from the electric motor 80 is reversed, the control board assembly 152 may return to a neutral position and compress a portion of the fluid in the second, lower fluid chamber 164 back into the first, upper fluid chamber 162.

The fluid-filled bladder 154 used in the shin-mounted control pack 60 may be made from a flexible, resilient material such as thermoplastic polyurethane (TPU) or a similar elastomer and may include a single layer or multi-layer construction. The fluid-filled bladder 154 may be constructed to include a closed internal volume that can maintain a certain quantity of a fluid. In some embodiments, the fluid may be a gaseous fluid and may include ambient air, pure nitrogen, or pure carbon dioxide. The walls of the fluid-filled bladder 154 may include one or more impermeable barrier layers that restrict the ability for the fluid within the internal volume to diffuse and/or escape through the wall of the fluid-filled bladder 154. The fluid-filled bladder 154 is designed to withstand repeated compression cycles without failure, and the specific geometry of the fluid-filled bladder 154, including the shape and size of the fluid chambers and the necked transition zone 166, can be optimized to provide the desired dampening characteristics. The fluid-filled bladder 154 may be sealed using various methods such as heat welding, RF welding, ultrasonic welding, or adhesive bonding to ensure an airtight seal.

### Shin Guard Closure

Referring again to FIG. 1 and FIGS. 14-16, the ambulatory assist device 30 may further include a closure 180 for securing the shin-mounted control pack 60 to the lower portion of the wearer's leg 12. Such a closure 180 may include one or more belts, bands, braces, or sleeves that are adapted to achieve a tension fit around a circumference of the lower leg 12. As used herein, a “tension fit” is intended to describe a contact-based fit where the closure 180 and/or related components encircle the leg 12 and provide an elastic compressive force to the body. To accomplish this, a certain amount of tensile force and elastic strain is elastically maintained within and across the closure 180. Ensuring a certain amount of compressive contact force between the device and the wearer's body will help maintain the device in place throughout a period of prolonged use.

In some embodiments, the closure 180 may include one or more elastic bands 182 that are threaded through corresponding slots in the shin-mounted control pack 60 and secured back to themselves through the use of a reusable fastener such as a hook-and-loop fastener. Alternatively, one or more clips, latches, or snaps may be used to directly secure an elastic band 182 extending behind and around the wearer's leg to the shin-mounted control pack 60. As may be appreciated, such an elastic band 182 may be formed from or otherwise include an elastomeric material that can repeatedly stretch without substantial plastic deformation. Examples of suitable elastomers include polymers such as polyurethane, rubber, polybutadiene, polyisobutylene, and/or certain silicones.

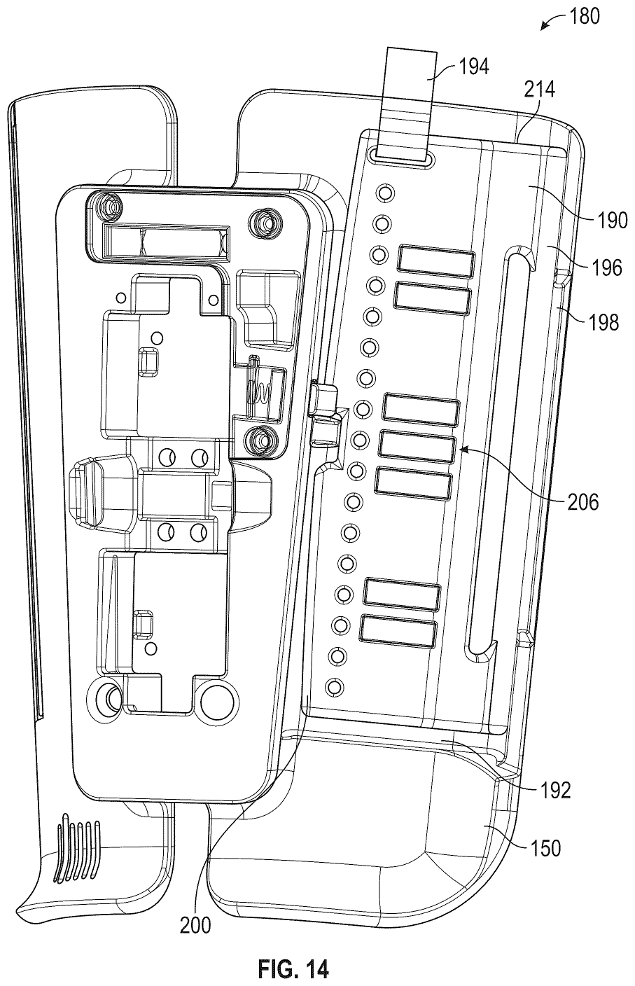

In an embodiment, such as schematically illustrated in FIGS. 14-16, the closure 180 may comprise a magnetic quick release mechanism for securely attaching an elastic band 182 about a portion of the wearer's lower leg 12. In this design, a closure panel 190 is held in close contact with a surface 192 of the padded shin guard 150 through a combination of magnetic forces and mechanical retention features, though is designed to quickly release from the padded shin guard 150 via a simple translation that is induced by the user at the pull of a tab 194.

In this design, a first edge 196 of the closure panel 190 may be configured to be inserted into or otherwise nest within an upstanding convex ledge 198 of the padded shin guard 150. For example, the edge 196 of the closure panel 190 may be a rounded or radiused edge and the convex ledge 198 may have a similar or marginally larger radius of curvature. Likewise, the convex ledge 198 may have a total arc of between about 100 degrees and about 170 degrees, or between about 100 degrees and 150 degrees.

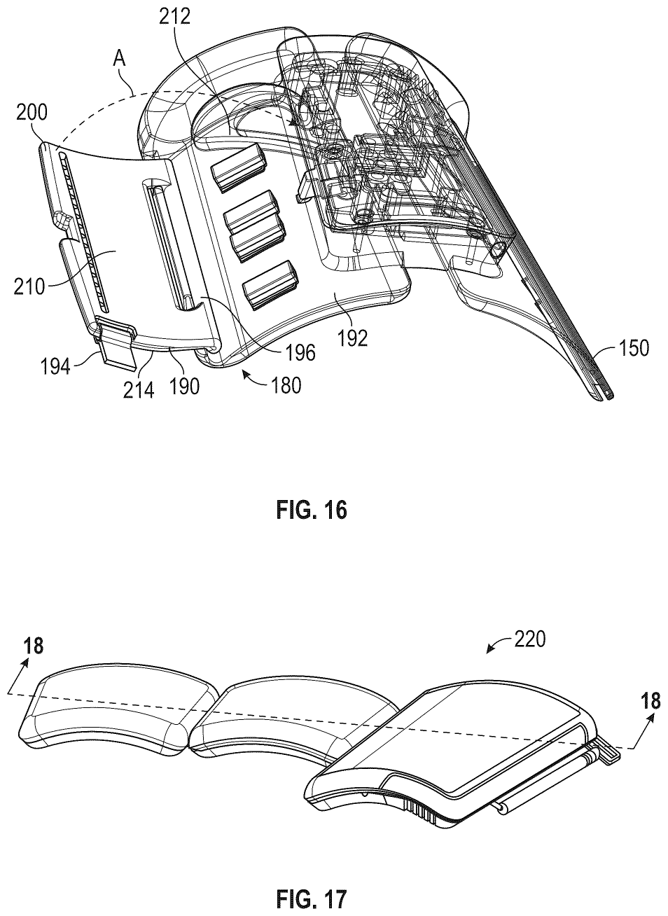

Once the first edge 196 is inserted into the convex ledge 198, such as shown in FIG. 16, the closure panel 190 may pivot around this edge contact as the opposing, second edge 200 traverses an arc A toward the padded shin guard 150. As the closure panel 190 draws closer to the padded shin guard 150, the second edge 200 may contact a biased retention latch 202 or detent feature. With further urging from the user, contact pressure between the second edge 200 and a sloped surface 204 of the retention latch 202 may overcome the spring bias and push the retention latch 202 into a non-interfering, retracted state. The user's manual urging of the closure panel 190 at this state may be assisted via the attraction of a plurality of magnet pairs 206, with a first magnet of each pair 206 being located within the closure panel 190 and a second magnet of each pair being located in the padded shin guard 150. Once the second edge 200 fully clears the retention latch 202, an inner surface 210 of the closure panel 190 may be in substantially flush contact with an outer surface 212 of the padded shin guard 150, and the retention latch 202 may return to its first, extended state where it then interferes with the second edge 200 from being pulled away from the padded shin guard 150 along its initial arc-like path of travel.

In some embodiments, the elastic band 182 may encircle the closure panel 190, or else may be attached to the closure panel 190 at a location between the first edge 196 and the second edge 200 (inclusive). In instances where the elastic band 182 is attached to the closure panel 190 apart from the first edge 196, the geometry and arcing action during the process of closing, together with the tension of the elastic band 182, creates an over-center locking action that further aids in keeping the closure panel 190 closed.

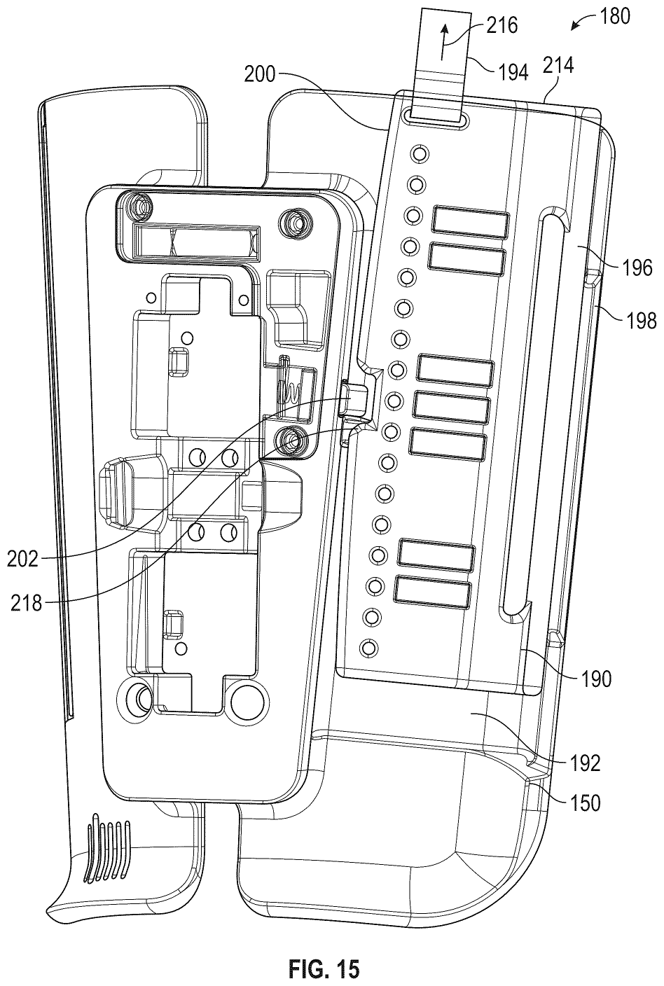

To release the closure panel 190, the wearer may pull the tab 194 provided on an upper edge 214 of the closure panel 190, such as shown in FIG. 15. This upper edge 214 extends between the first edge 196 and the second edge 200, and the pulling motion is generally made in a direction that is parallel to both the first edge 196 and the second edge 200. The pull force 216 applied through the pull tab 194 causes the closure panel 190 to translate upward. In doing so, a notched portion 218 of the second edge 200 translates into alignment with the retention latch 202 such that the retention latch 202 no longer interferes with the removal of the second edge 200 and closure panel 190 from the padded shin guard 150.

In addition to removing the retention latch 202 as an impediment to panel removal, the induced translation may further alter the magnet arrangement to repel/eject the closure panel 190 from the outer surface 212 of the padded shin guard 150. More specifically, in some embodiments, one or more reversed polarity magnets may be interspersed among the magnet pairs 206 such that the translation of the closure panel 190 forms new magnet pairings that repel instead of attract.

### Battery Pack

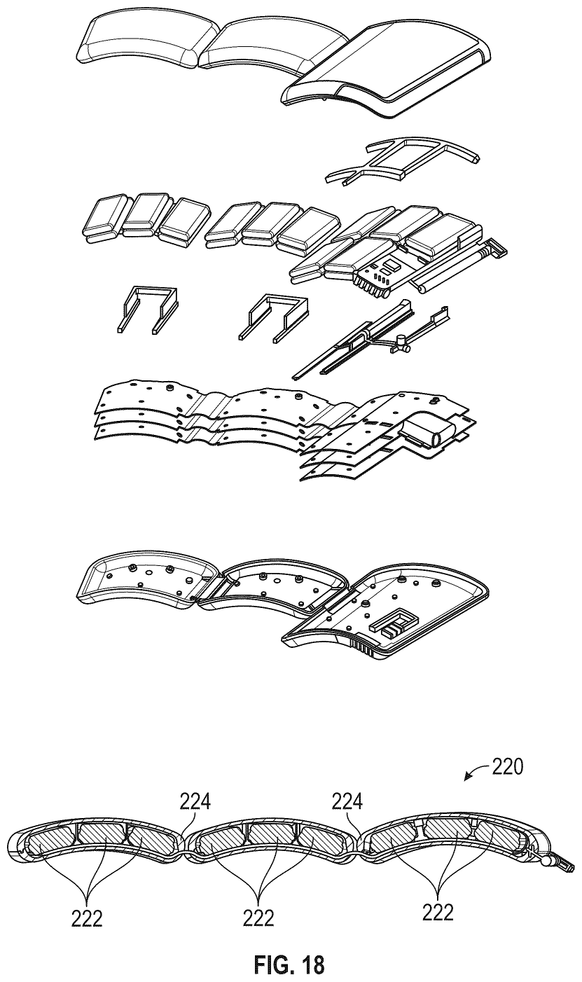

As generally shown in FIGS. 17-18, in some embodiments, the elastic band 182 may include or otherwise be coupled to one or more battery packs 220. In some embodiments, these battery packs 220 may be removable from the elastic band 182 to facilitate ease of recharging. By situating the battery packs 220 around the circumference of the wearer's leg, the weight of this system 30 may be more efficiently distributed to provide a more ergonomic and unobtrusive experience for the wearer. In some configurations, the battery packs 220 may be flexible or semi-flexible components that are able to at least partially conform to the curvature of the wearer's leg.

In some embodiments, as shown in FIG. 17-18, the battery packs 220 may comprise one or more rigid cells 222 that are connected by flexible sections 224. Such a design would allow the overall battery pack 220 to bend and conform in at least one degree of freedom (e.g., to be wrapped around the wearer's leg 12), while the individual cells 222 do not directly flex.

In alternate embodiments, a flexible battery may include one or more thin, bendable electrodes made from materials such as carbon nanotubes, graphene, conductive polymers, or composites with silicon or tin-based materials for anodes, and lithium transition metal oxides or lithium iron phosphate for cathodes. These electrode materials are deposited or printed onto flexible substrates, such as polymer films, textiles, or metal foils, which serve as the foundation for the battery assembly.

To maintain ionic conductivity while allowing flexibility, the flexible battery can employ solid or gel polymer electrolytes, such as polyethylene oxide (PEO) or polyacrylonitrile (PAN) based electrolytes. Flexible separators, made from materials like polyethylene, polypropylene, or ceramic coatings, can be used to prevent short circuits while enabling ion transport between the electrodes. The battery components are connected using flexible current collectors, such as carbon nanofiber mats, metal foils, or conductive polymers, which efficiently collect and transport electrons from the electrodes.

The entire battery pack 220 may be encapsulated in flexible and durable packaging materials, such as polymer laminates or coatings, to protect the internal components from environmental factors and mechanical stress while still permitting compliance of the overall design.

While the present design illustrates certain features in connection with an ambulatory assist device 30, this should not preclude such features from finding applicability in other contexts. For example, the fluid-filled bladder 154 may be useful in connection with other cushioning needs, for example, in chair cushions, footwear, backpack straps, or other such items that experience dynamic and/or cyclic loading and require dampening. Similarly, the magnetic quick release mechanism for fastening the elastic band 182 may find utility to secure smartphones or other wearable devices to a limb of a user, or may be used to fasten other such equipment to posts, beams, rods, tubes, or the like. For example, such a closure may be used to secure a pack to a down tube or top tube of a bicycle frame, or may be used to secure a trail camera to a tree, or a speaker to a lamp post. In a similar manner, the quick disconnect coupling 40 with the keyed post 110 inserted into the mating quick disconnect receiver 112 may be used for other purposes, such as selectively attaching repositionable phone holders to a quick disconnect receiver in a counter wall, or piece of furniture, or a swivelable snack tray to a quick disconnect receiver in the arm of a couch or chair.

1. An ambulatory assist device comprising:
a shin-mounted control pack configured to be secured to a lower leg of a wearer;
a drive unit rigidly coupled to the shin-mounted control pack via an upper control arm, the drive unit comprising a riser and a motor assembly attached to the riser;
a lower control arm rotatably coupled to the drive unit and configured to be rotatably coupled to an article of footwear;
a drive belt that extends between the motor assembly and the lower control arm, wherein the motor assembly is operatively configured to tension the drive belt;
wherein the motor assembly is configured to apply a force to the lower control arm via the tensioned drive belt to cause the lower control arm to pivot about a rotatable joint.

2. The ambulatory assist device of claim 1, wherein the shin-mounted control pack is configured to be worn on an anterior surface of the wearer's lower leg, the drive unit is configured to be positioned on a lateral side portion of the wearer's lower leg, and the lower control arm is configured to connect to a posterior portion of the article of footwear.

3. The ambulatory assist device of claim 1, wherein the riser of the drive unit comprises a first end portion coupled with the upper control arm, and a second end portion that includes the rotatable joint to which the lower control arm is coupled.

4. The ambulatory assist device of claim 1, wherein the drive belt extends around a pulley on the lower control arm, the pulley being offset from the rotatable joint to increase mechanical advantage of the motor assembly.

5. The ambulatory assist device of claim 1, wherein the shin-mounted control pack comprises control electronics including one or more of processors, controllers, memory devices, communication circuits, antenna, batteries, power electronics, accelerometers, inertial measurement units, or gyrometers.

6. The ambulatory assist device of claim 1, wherein the lower control arm is configured to be coupled with the article of footwear via a quick disconnect coupling.

7. An ambulatory assist device comprising:
a control pack configured to be secured to a lower leg of a wearer;
a drive unit coupled to the control pack;
a lower control arm rotatably coupled to the drive unit; and
a quick disconnect coupling configured to rotatably couple the lower control arm to an article of footwear, the quick disconnect coupling comprising:
a first portion provided on the lower control arm; and
a second portion configured to be provided on the article of footwear;
wherein the first portion is configured to selectively interconnect with the second portion and includes a user-activated release mechanism.

8. The ambulatory assist device of claim 7, wherein the quick disconnect coupling comprises a keyed post configured to be inserted within a mating quick disconnect receiver.

9. The ambulatory assist device of claim 8, wherein the keyed post has a non-radially symmetric cross-sectional profile that facilitates insertion while preventing unintended rotation of the keyed post within the mating quick disconnect receiver.

10. The ambulatory assist device of claim 8, wherein the quick disconnect coupling further comprises a latching mechanism including a latching protrusion configured to selectively extend proud of an outer surface of the keyed post and catch on a corresponding retention edge of the mating quick disconnect receiver when fully inserted.

11. The ambulatory assist device of claim 10, wherein the latching protrusion is biased in an extended position via an interconnected spring, and wherein the user-activated release mechanism comprises an upstanding tab configured to overcome a spring force of the interconnected spring and cause the latching protrusion to retract within the keyed post.

12. The ambulatory assist device of claim 7, wherein the quick disconnect coupling includes a rotatable joint configured to permit the article of footwear to rotate relative to the lower control arm about an axis substantially parallel to a longitudinal axis of the article of footwear.

13. An ambulatory assist device comprising:
a shin-mounted control pack configured to be secured to a lower leg of a wearer, the shin-mounted control pack comprising:
a padded shin guard;
a control board assembly; and
a fluid-filled bladder provided between at least a portion of the control board assembly and the padded shin guard;
a drive unit rigidly coupled to the shin-mounted control pack; and
a lower control arm rotatably coupled to the drive unit.

14. The ambulatory assist device of claim 13, wherein the fluid-filled bladder comprises a first, upper fluid chamber in fluidic communication with a second, lower fluid chamber.

15. The ambulatory assist device of claim 14, wherein the fluid-filled bladder further comprises a necked transition zone between the first, upper fluid chamber and the second, lower fluid chamber, the necked transition zone limiting fluid movement between the first, upper fluid chamber and the second, lower fluid chamber.

16. The ambulatory assist device of claim 13, wherein the padded shin guard has a curved shape that includes a compliant padding on a concave side that is configured to directly contact the wearer's lower leg.

17. The ambulatory assist device of claim 13, further comprising a closure for securing the shin-mounted control pack to the lower leg of the wearer, the closure comprising:
a closure panel;
an elastic band connected to the closure panel; and
a magnetic quick release mechanism configured to hold the closure panel in close contact with a surface of the padded shin guard through a combination of magnetic forces and mechanical retention features.
